(19) United States
(12) Patent Application Publication
(10) Pub. No.: US 2014/0291176 A1
(43) Pub. Date: Oct. 2, 2014

(54) Tablet Computer Cover and Stand

(71) Applicant: MARWARE, INC., Hollywood, FL (US)

(72) Inventor: Chanseol Chung, Hollywood, FL (US)

(73) Assignee: Marware, Inc., Hollywood, FL (US)

(21) Appl. No.: 13/854,639

(22) Filed: Apr. 1, 2013

(51) Int. Cl. G06F 1/16

(52) U.S. Cl. CPC G06F 1/1656
USPC 206/45.23

(57) ABSTRACT

A tablet computer cover and stand includes a front cover and a rear cover interconnected by an intermediate hinge and configured to enclose a tablet computer therebetween in a closed condition. The front and rear covers have respective inner and outer surfaces and the inner surface of the front cover has an anti-slip surface. A shell is rotatable on the rear cover about a rear cover hinge disposed within the rear cover and the shell is configured to hold the tablet computer. The shell has a free end configured to engage anywhere on the anti-slip surface upon opening the front and rear covers about the intermediate hinge and rotating the shell about the rear cover hinge from the closed condition to a standing position.

### BACKGROUND OF THE INVENTION

1. Field of the Invention

The invention relates to a tablet computer cover and stand, which is adjustable into different viewing angles and positions.

2. Description of the Related Art

A tablet computer is a one-piece, mobile computer which typically has a touch screen. Tablet computers, such as the iPad®, are monolithic devices which, unlike laptop computers, require a stand to hold them in a comfortable position for viewing or typing. They also are subject to soiling, wear and damage due to shocks and therefore require covers for protection.

Many prior art devices provide such functions, but are generally only movable into two positions and therefore do not permit the tablet computer to be displayed in several different positions which are required for the many applications for which they are used, such as typing, watching videos and delivering presentations to a group.

### BRIEF SUMMARY OF THE INVENTION

It is accordingly an object of the invention to provide a tablet computer cover and stand, which overcomes the above-mentioned disadvantages of the heretofore-known devices of this general type and which permits a tablet computer to be displayed in several varied positions which are required for different applications.

With the foregoing and other objects in view there is provided, in accordance with the invention, a tablet computer cover and stand, comprising a front cover and a rear cover interconnected by an intermediate hinge and configured to enclose a tablet computer therebetween in a closed condition. The front and rear covers have respective inner and outer surfaces and the inner surface of the front cover has an anti-slip surface. A shell is rotatable on the rear cover about a rear cover hinge disposed within the rear cover and the shell is configured to hold the tablet computer. The shell has a free end configured to engage anywhere on the anti-slip surface upon opening the front and rear covers about the intermediate hinge and rotating the shell about the rear cover hinge from the closed condition to a standing position.

The anti-slip surface provides an infinitely adjustable viewing angle of the tablet computer by moving the free end of the shell along the anti-slip surface. The anti-slip surface may be located in one or more discrete, separate patches or strips on the inner surface of the front cover. Thus, according to the invention, the computer may be protected against damage and soiling and may be displayed at different viewing angles by using one and the same cover and stand.

In accordance with another feature of the invention, the front and rear covers are configured to be folded back about the intermediate hinge into a folded condition with the outer surfaces of the front and rear covers lying against each other and the shell facing outward. In this folded condition, the shell is exposed and holds the computer in such a way as to face outward.

In accordance with a further feature of the invention, at least one pin, such as a rivet, is connected to the rear cover and passes through at least one respective slot in the shell, permitting the shell to slide relative to the rear cover in the folded condition, although at least two and preferably three pins and slots are provided. The shell has an opening formed therein which is in alignment with a lens of a camera of the tablet computer, and the opening is covered and uncovered by the rear cover when sliding the shell in the folded condition.

In accordance with an added feature of the invention, a connector, such as a snap, interconnects the shell and the rear cover. The connector is easy to unfasten permitting the shell to slide.

In accordance with a concomitant feature of the invention, hooks are disposed on one of the covers, straps are spring-loaded for retraction into the other of the covers and a closure tab is attached to the straps and configured to be engaged behind the hooks for locking the computer cover and stand in the closed condition. This construction provides security against the cover accidentally opening and being susceptible to damage and soiling.

Other features which are considered as characteristic for the invention are set forth in the appended claims.

Although the invention is illustrated and described herein as embodied in a tablet computer cover and stand, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIGS. 1 and 2 are diagrammatic, front-elevational and side-elevational views respectively showing a tablet computer cover and stand according to the invention, in a closed condition with a shell for holding a tablet computer disposed therein;

FIG. 3 is a top-plan view showing the inside of the cover and stand in an open condition with the shell for holding the computer in the portrait orientation;

FIG. 4 is a front-perspective view of the cover and stand in the closed condition;

FIGS. 5 and 6 are front-perspective views showing the operation of a closure tab of the cover and stand;

FIGS. 7 and 8 are top-plan and side-elevational views respectively showing the inside of the cover and stand in the open condition with the shell in the landscape orientation;

FIGS. 9 and 10 are top-perspective and side-elevational views respectively showing the shell being unsnapped and lifted from the rear cover;

FIGS. 11 and 12 are side-perspective and side-elevational views respectively showing the cover and stand in the standing position;

FIG. 13 is a rear-perspective view of the shell rotated through 90° as compared to FIG. 11 and showing rubbery, anti-slip material;

FIGS. 14 and 15 are front-elevational views of the shell and the front cover in a flipped-back position; and

FIGS. 16 and 17 are views similar to FIGS. 14 and 15 but with the shell slid up to expose an opening for a camera lens.

### DETAILED DESCRIPTION OF THE INVENTION

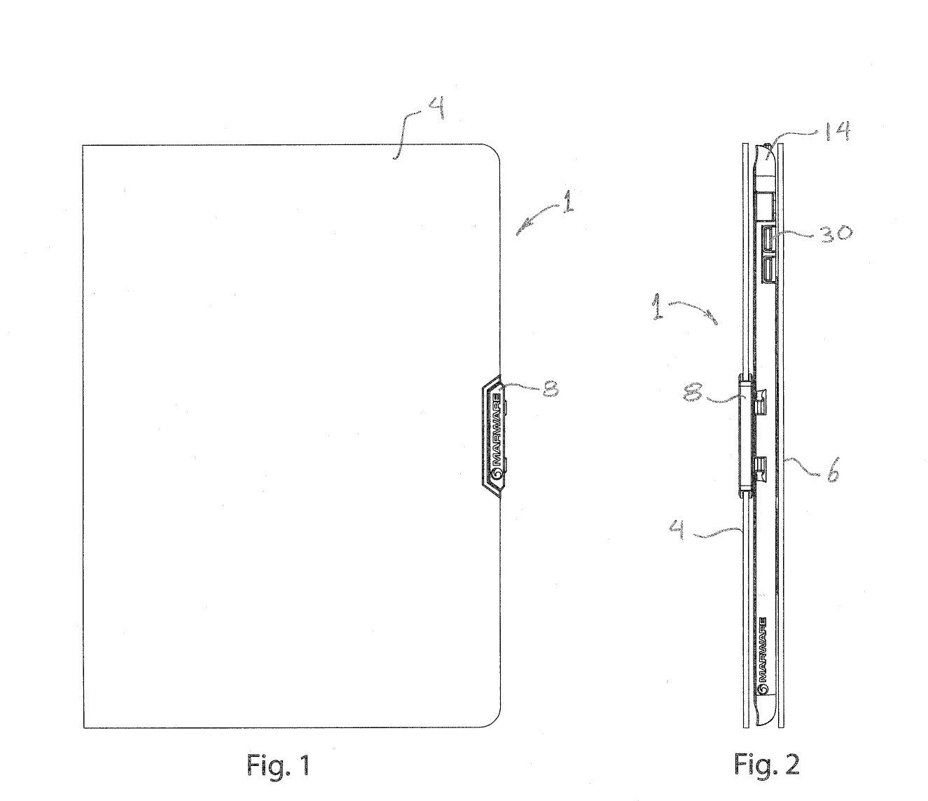

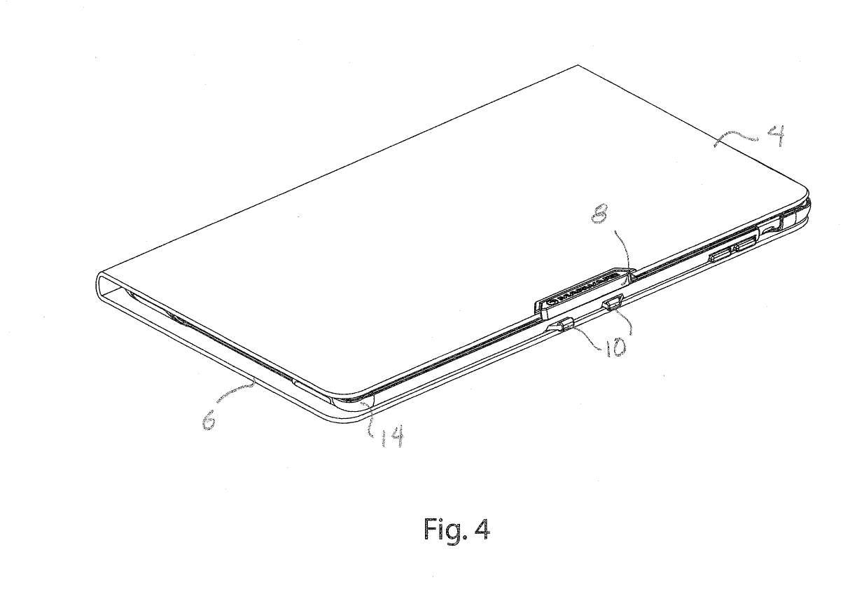

Referring now to the figures of the drawing in detail and first, particularly, to FIGS. 1, 2 and 4 thereof, there is seen a tablet computer cover and stand 1 in a closed condition. The cover and stand 1 includes a front folio cover 4 and a rear folio cover 6 surrounding a shell 14 which holds a tablet computer 30 in such a way that only USB ports of the computer 30 can be seen. A closure tab 8 for locking the covers 4, 6 together is shown in a retracted and open position in FIG. 4, in which it is released from hooks 10.

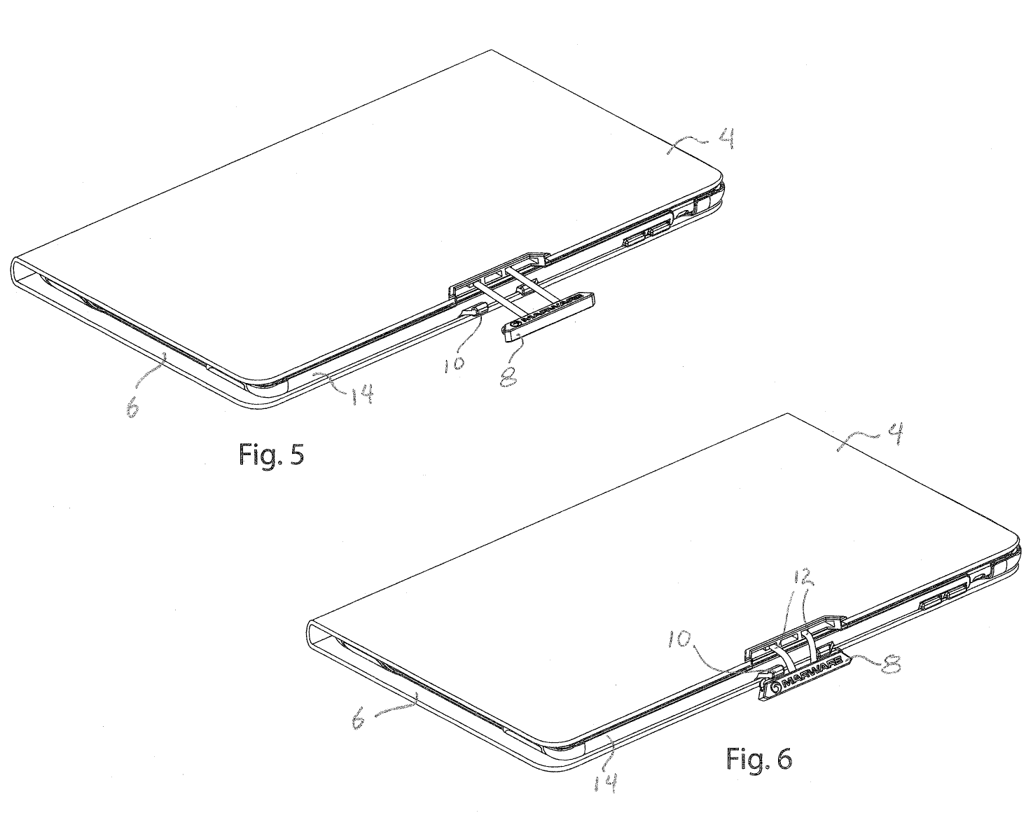

FIGS. 5 and 6 show that the closure tab 8 is attached to straps 12 which are guided through slots in the front folio cover 4 and are spring-loaded to pull the straps and therefore the closure tab 8 towards the front folio cover 4. The closure tab 8 is operated by pulling the closure tab 8 and extracting the straps 12 as shown in FIG. 5 and locking the closure tab 8 below the hooks 10 as shown in FIG. 6.

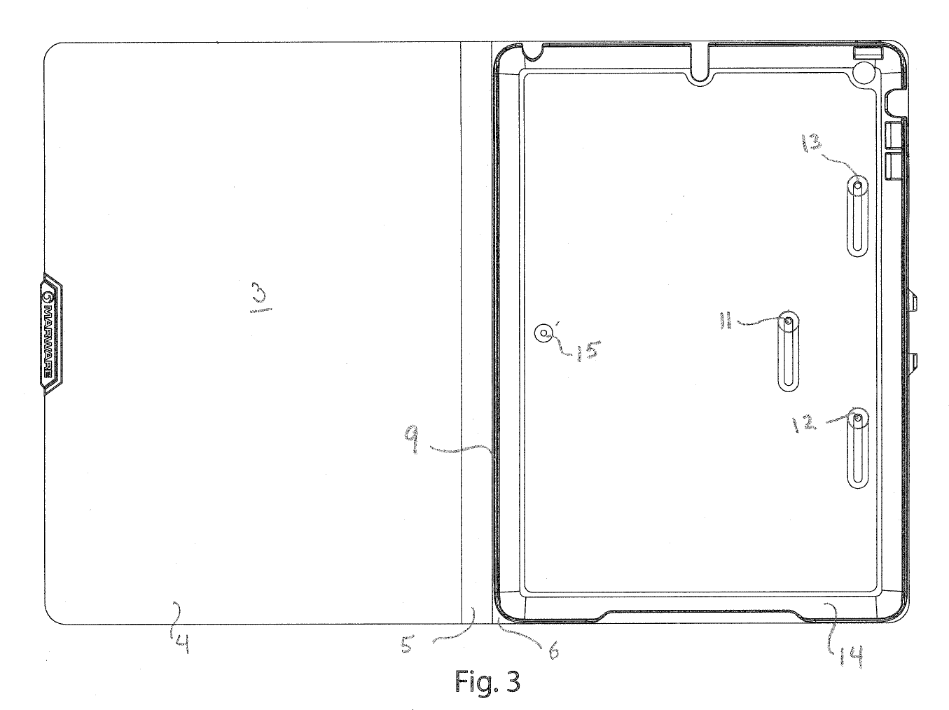

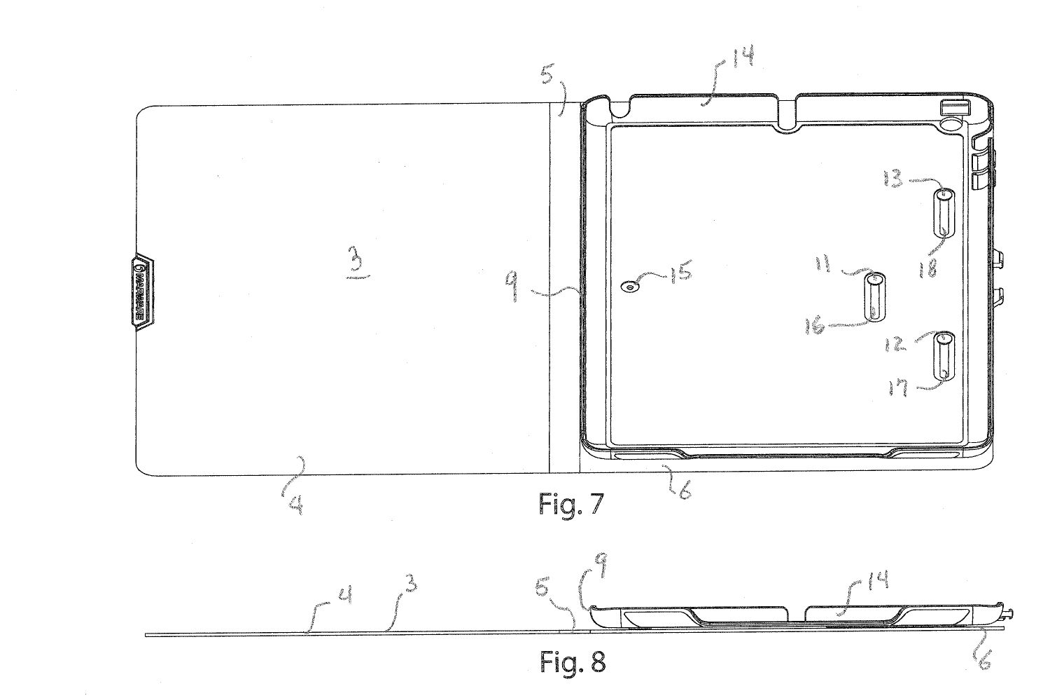

FIGS. 3, 7 and 8 show the cover and stand 1 in an open condition, from which it can be seen that the front and rear covers 4, 6 are interconnected by a living or live intermediate hinge 5 and that the shell 14 for holding the tablet computer 30 is connected to the rear folio cover 6 by rivets 11, 12, 13 and a snap 15. The side of the shell 14 adjacent the living hinge 5 may be lifted to open the snap 15, which permits the shell 14 to be slid along the rivets 11, 12, 13 that are guided in respective slots 16, 17 and 18. The shell 14, which is shown in a portrait orientation in FIG. 3 and in a landscape orientation in FIGS. 7 and 8, may be guided upward along the rivets from a lower position shown to an upper position to be discussed below. Of course, any type of pin may be used instead of the rivets 11, 12, 13, only one pin or rivet is necessary and any type of connector may be used instead of the snap 15. FIGS. 3, 7 and 8 also indicate that the inside of the front cover 4 is at least partially covered with rubbery, anti-slip material 3.

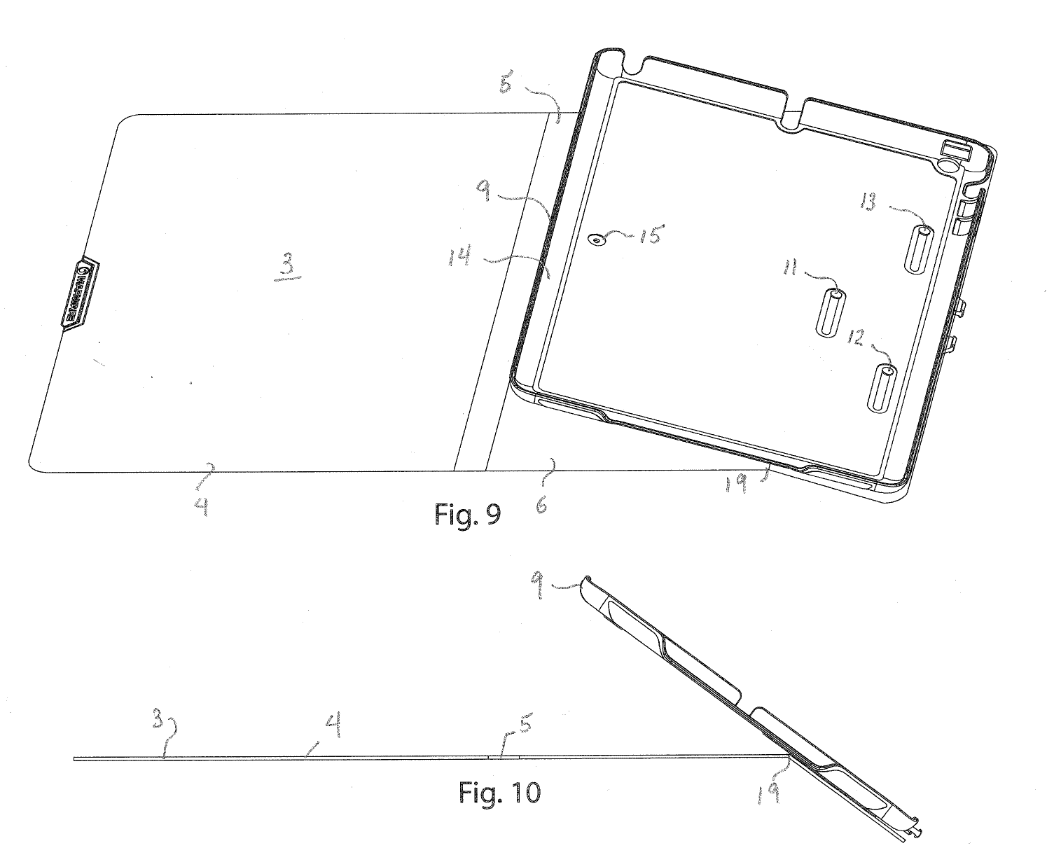

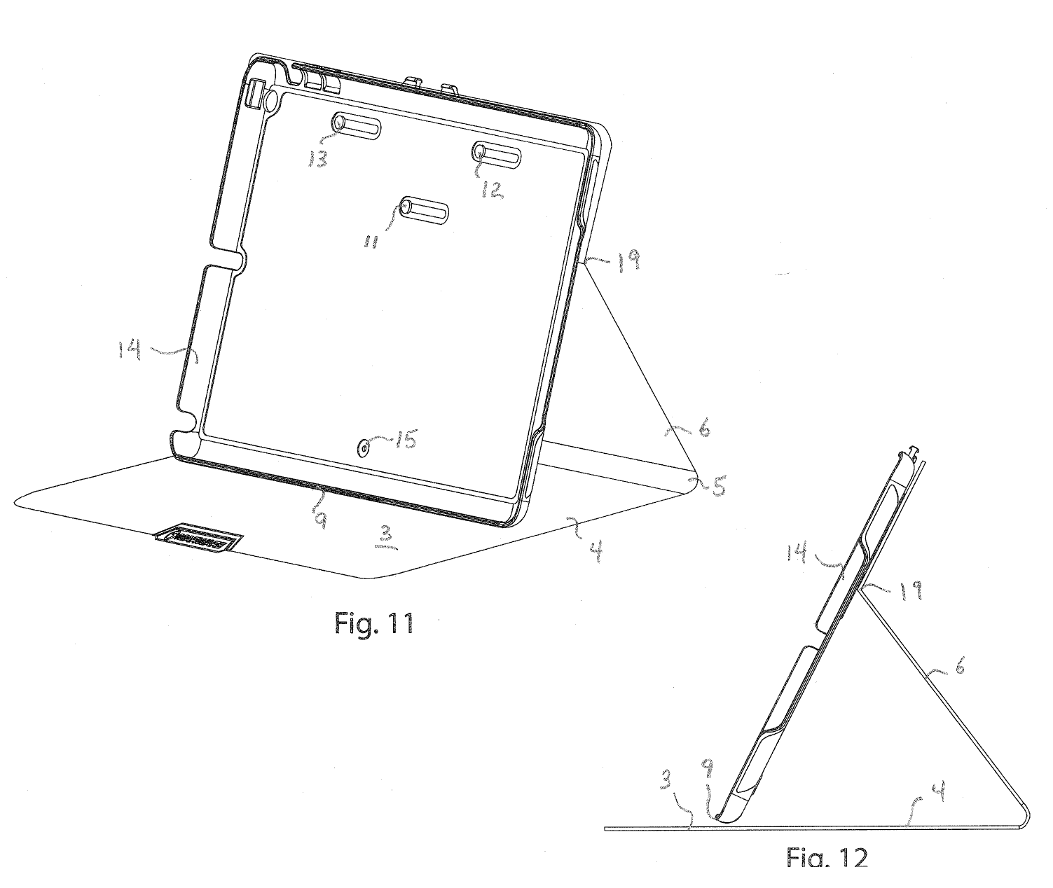

FIGS. 9 and 10 show the shell 14 after being unsnapped and lifted from the rear cover 6 about a living or live rear cover hinge 19 of the rear cover 6. FIGS. 11 and 12 show the cover and stand 1 rotated from the position shown in FIGS. 9 and 10 about the living or live hinge 5, until a free end 9 of the shell 14 facing away from the rear cover 6 rests on the rubbery, anti-slip material 3. The cover and stand 1 is then in a standing position.

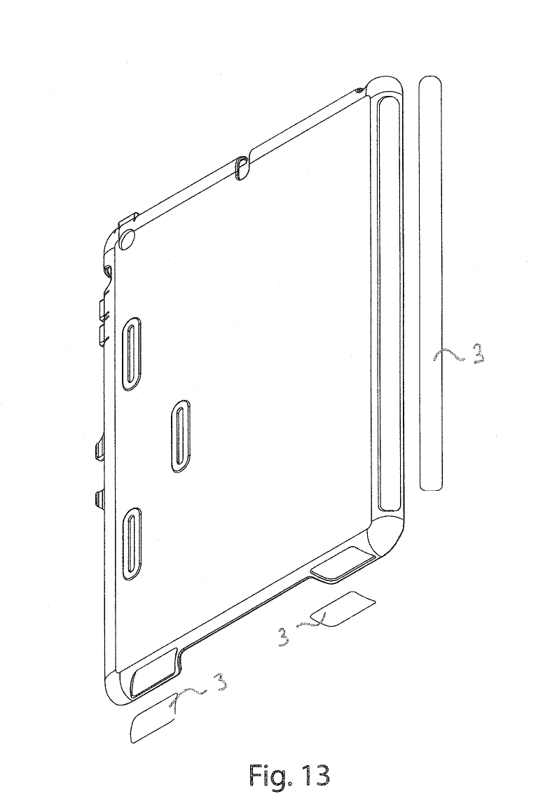

FIG. 13 shows that the rubbery, anti-slip material 3 need only be located in one or more discrete, separate patches or strips 3, which is sufficient to grab and hold the free end 9 of the shell 14. The size, shape and placement of the patches or strips 3 depends on the shape and orientation of the shell 14.

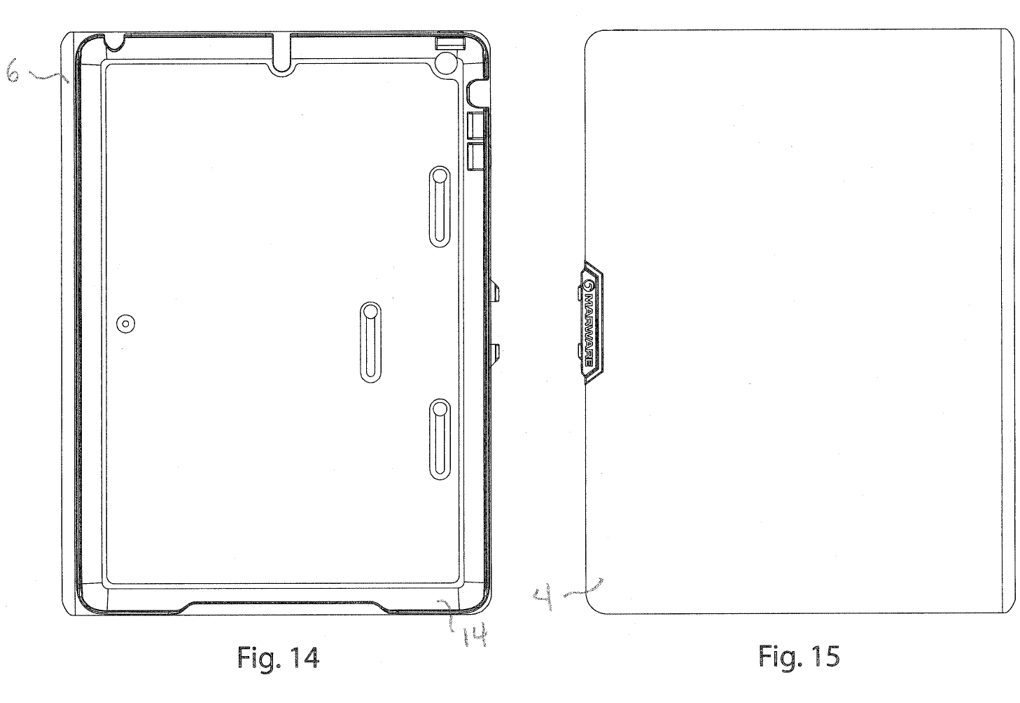

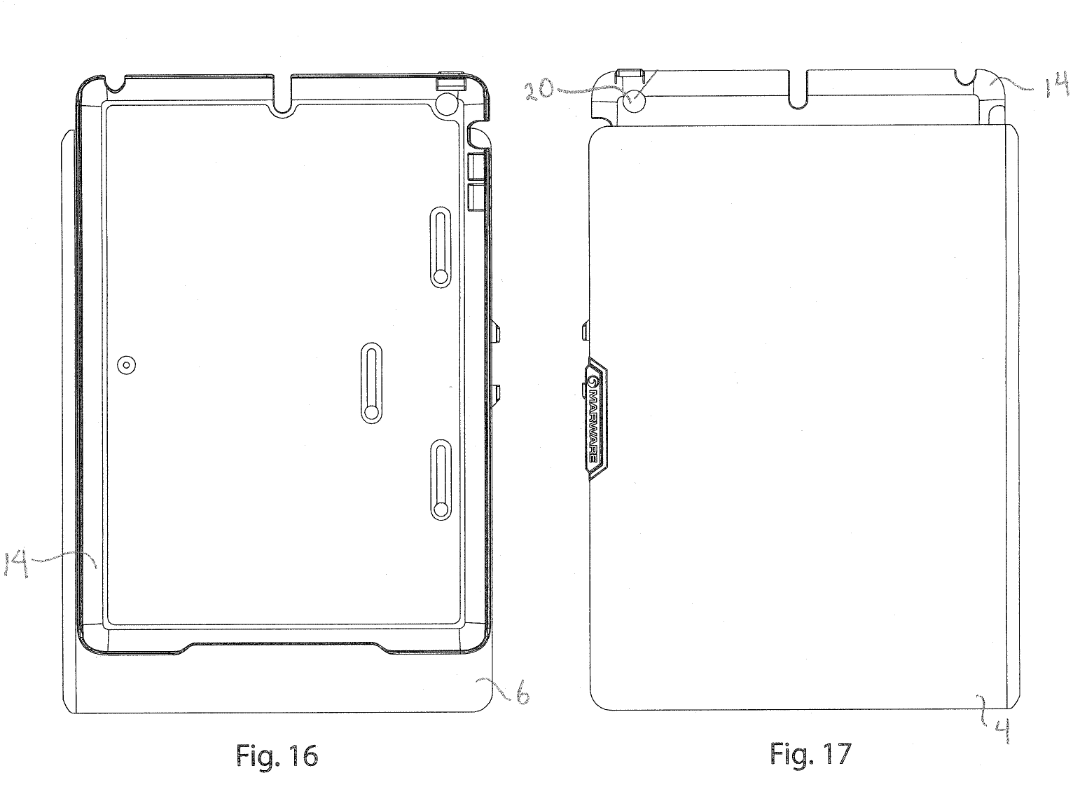

FIGS. 14-17 show a folded condition of the cover and stand 1 in which the front cover 4 is rotated back against the rear cover through 180° about the hinge 5, so that the shell 14 is completely exposed on one side and the inner surface of the front cover 4 is completely exposed on the other side, for holding the cover and stand 1 in the hands rather than in the standing position. The difference between the figures is that in FIGS. 14 and 15, the shell 14 has been slid into the lower position as seen by the rivets 11, 12, 13 located at the tops of the slots 16, 17, 18, whereas in FIGS. 16 and 17 the shell 14 has been slid into the upper position, so as to uncover an opening 20 in the shell 14 exposing a lens of a camera of the tablet computer.

1. A tablet computer cover and stand, comprising:
a front cover and a rear cover interconnected by an intermediate hinge and configured to enclose a tablet computer therebetween in a closed condition, said front and rear covers having respective inner and outer surfaces and said inner surface of said front cover having an anti-slip surface; and
a shell rotatable on said rear cover about a rear cover hinge disposed within said rear cover, said shell configured to hold the tablet computer, and said shell having a free end configured to engage anywhere on said anti-slip surface upon opening said front and rear covers about said intermediate hinge and rotating said shell about said rear cover hinge from said closed condition to a standing position.

2. The tablet computer cover and stand according to claim 1, wherein said anti-slip surface provides an infinitely adjustable viewing angle of the tablet computer by moving said free end of said shell along said anti-slip surface.

3. The tablet computer cover and stand according to claim 1, wherein said anti-slip surface is located in one or more discrete, separate patches or strips on said inner surface of said front cover.

4. The tablet computer cover and stand according to claim 1, wherein said front and rear covers are configured to be folded back about said intermediate hinge into a folded condition with said outer surfaces of said front and rear covers lying against each other and said shell facing outward.

5. The tablet computer cover and stand according to claim 4, which further comprises at least one pin connected to said rear cover and passing through at least one respective slot in said shell, permitting said shell to slide relative to said rear cover in said folded condition.

6. The tablet computer cover and stand according to claim 5, wherein said shell has an opening formed therein configured to be in alignment with a lens of a camera of the tablet computer, and said opening is covered and uncovered by said rear cover when sliding said shell in said folded condition.

7. The tablet computer cover and stand according to claim 5, which further comprises a connector interconnecting said shell and said rear cover.

8. The tablet computer cover and stand according to claim 7, wherein said at least one pin is at least one rivet and said connector is a snap.

9. The tablet computer cover and stand according to claim 1, which further comprises hooks disposed on one of said covers, straps spring-loaded for retraction into the other of said covers and a closure tab attached to said straps and configured to be engaged behind said hooks for locking the computer cover and stand in said closed condition.
